(19) United States
(12) Patent Application Publication
(10) Pub. No.: US 2020/0401071 A1
(43) Pub. Date: Dec. 24, 2020

(54) IMAGE FORMING APPARATUS, CONTROL METHOD THEREFOR, AND PROGRAM

(71) Applicant: Konica Minolta Inc., Tokyo (JP)

(72) Inventors: Yuki ASAI, Itami-shi (JP); Hisashi UCHIDA, Kumiyama-cho (JP); Hiroaki KUBO, Muko-shi (JP)

(21) Appl. No.: 16/872,998

(22) Filed: May 12, 2020

(30) Foreign Application Priority Data
Jun. 19, 2019 (JP) 2019-113458

(51) Int. Cl. G03G 15/00; G03G 15/08

(52) U.S. Cl. CPC G03G 15/5016; G03G 15/0863; G03G 15/5087

(57) ABSTRACT

An image forming apparatus includes: an image processor that performs predetermined processing on image data; and an image former that forms an image of the image data that has been subjected to the predetermined processing, in which the image processor: includes a file memory; when image data has a low resolution, stores the image data in the file memory, and performs detection processing of detecting whether a predetermined pattern is contained on the image data; and when image data has a high resolution, performs resolution processing of converting the image data to have a predetermined resolution in parallel with binarization processing, and performs the detection processing on the image data.

The entire disclosure of Japanese patent Application No. 2019-113458, filed on Jun. 19, 2019, is incorporated herein by reference in its entirety.

### BACKGROUND

### Technological Field

The present disclosure relates to an image forming apparatus, and more particularly, to an image forming apparatus that performs detection processing of detecting whether a predetermined pattern is contained.

### Description of the Related Art

In recent years, qualities of images formed by image forming apparatuses such as Multi-Functional Peripherals (MFPs) have been improved. In this sense, detection processing on image data for printing has had significant meaning. The detection processing is performed to avoid printing of images that are inhibited to be printed, such as securities and bank bills.

Regarding such detection processing, for example, JP 2002-335399 A discloses a technique that uses data buses in accordance with the input forms or resolutions of image data and improves print performance by using a low-resolution image in a part of detection processing.

In the technique in JP 2002-335399 A, print performance can be improved by acquiring pieces of data of a plurality of resolutions for one print job. Unfortunately, when print jobs having different resolutions are continually processed, a processing delay that occurs between the jobs cannot be prevented since the resolutions with which processing is performed are switched. For example, when a job containing a high-resolution image is sequentially processed after a job containing a low-resolution image, the difference between resolutions of images causes difference in the processing content. Detection processing on the high-resolution image thus needs to be performed after detection processing on the low-resolution image. The start of processing of printing the high-resolution image on a sheet is delayed.

It is also conceivable to provide a dedicated circuit for the detection processing on each of high-resolution image data and low-resolution image data. In such a case, however, the circuit scale in the image forming apparatus is increased. A situation of significantly increasing manufacturing costs for the image forming apparatus can be assumed.

### SUMMARY

The disclosure has been devised in view of such circumstances, and an object thereof is to provide a technique for reducing manufacturing costs while avoiding a delay in processing on image data.

To achieve the abovementioned object, according to an aspect of the present invention, an image forming apparatus reflecting one aspect of the present invention comprises: an image processor that performs predetermined processing on image data; and an image former that forms an image of the image data that has been subjected to the predetermined processing, in which the image processor: includes a file memory; when image data has a low resolution, stores the image data in the file memory, and performs detection processing of detecting whether a predetermined pattern is contained on the image data; and when image data has a high resolution, performs resolution processing of converting the image data to have a predetermined resolution in parallel with binarization processing, and performs the detection processing on the image data.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates one example of a usage aspect of an image forming apparatus;

FIG. 2 illustrates one example of the hardware configuration of the image forming apparatus;

FIG. 3 illustrates one example of the functional configuration of an image processor;

FIG. 4 is a flowchart of processing of transferring input image data in the image processor;

FIG. 5 is a timing chart in the case where low-resolution jobs are continually executed;

FIG. 6 is a timing chart in the case where high-resolution jobs are continually executed;

FIG. 7 illustrates one example of a timing chart in the case where a high-resolution job is executed after a low-resolution job and no delay occurs;

FIG. 8 illustrates one example of a timing chart in the case where a high-resolution job is executed after a low-resolution job and resolution processing is performed;

FIG. 9 illustrates one example of a timing chart in the case where a high-resolution job is executed after a low-resolution job and a delay occurs;

FIG. 10 illustrates one example of the configuration of an image processor corresponding to the example of FIG. 9; and

FIG. 11 is a flowchart of processing, which corresponds to the example of FIG. 9, of transferring input image data to the image processor.

### DETAILED DESCRIPTION OF EMBODIMENTS

Hereinafter, one embodiment of an image forming apparatus of the present invention will be described with reference to the drawings. However, the scope of the invention is not limited to the disclosed embodiments. In the following description, the same parts and components are assigned the same sign. The same parts and components have the same name and function. The description thereof will thus not be repeated.

### [Usage Aspect of Image Forming Apparatus]

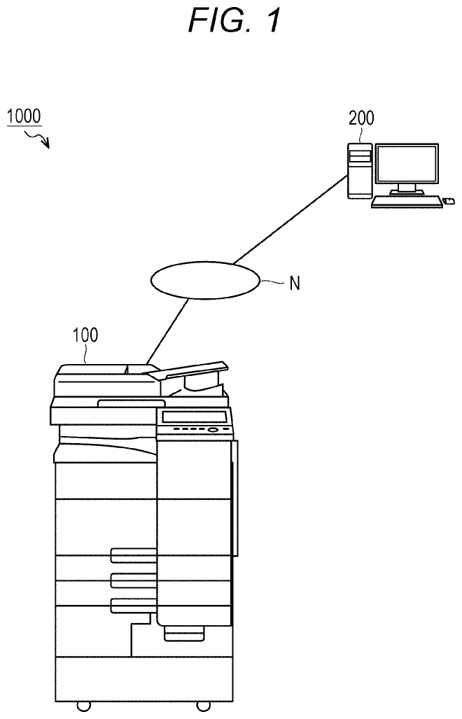

FIG. 1 illustrates one example of a usage aspect of an image forming apparatus. As illustrated in FIG. 1, an image forming system 1000 includes an image forming apparatus 100 and a user terminal 200. The image forming apparatus 100 may be a combined machine such as an MFP, or may be a printer. The user terminal 200 may be a general-purpose computer, or a mobile terminal such as a smartphone. The image forming apparatus 100 and the user terminal 200 can communicate with each other via a network N.

### [Hardware Configuration of Image Forming Apparatus]

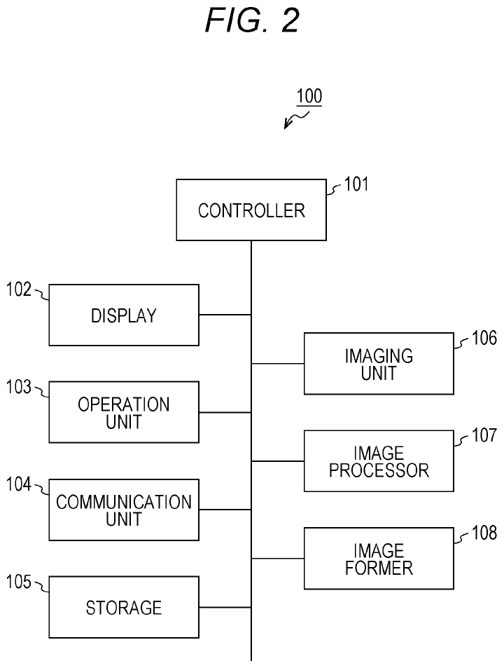

FIG. 2 illustrates one example of the hardware configuration of the image forming apparatus 100.

The image forming apparatus 100 includes a controller 101 for controlling the entire image forming apparatus 100. The image forming apparatus 100 further includes a display 102, an operation unit 103, a communication unit 104, a storage 105, an imaging unit 106, an image processor 107, and an image former 108. These components are connected to the controller 101 via an internal bus.

The controller 101 includes a central processing unit (CPU). The display 102 is implemented by a display device such as a liquid crystal display, an organic electro-luminescence (OEL) display, and/or a lamp. The operation unit 103 is implemented by an input device such as a display (software key) and/or a hardware key.

The communication unit 104 is implemented by a communication interface such as a local area network (LAN) card. The storage 105 is implemented by a storage device such as a hard disk drive (HDD) and/or a solid state drive (SSD). The imaging unit 106 is implemented by an imaging device such as an image sensor.

The image processor 107 is implemented by, for example, an arithmetic device (e.g., circuitry) and a memory. The arithmetic device performs processing such as rasterization and binarization on image data. The memory stores data of the arithmetic result.

The image former 108 is implemented by, for example, a printer unit. The printer unit includes a photoconductor, an ink cartridge driving circuit, a roller, and a motor. The photoconductor forms an electrostatic latent image. The ink cartridge driving circuit supplies ink for forming an image. The roller conveys printing paper. The motor drives the roller.

### [Functional Configuration of Image Forming Apparatus]

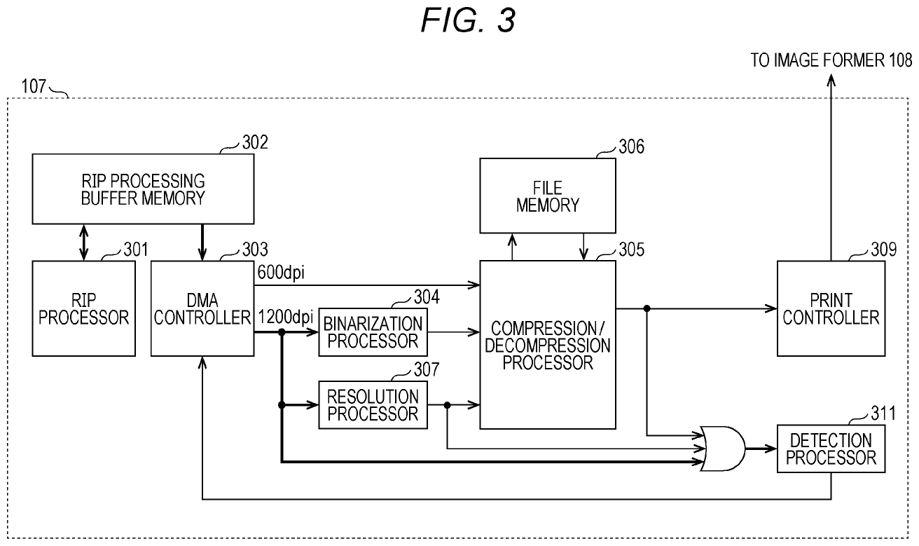

FIG. 3 illustrates one example of the functional configuration of the image processor 107. The image processor 107 includes a raster image processor (RIP) processor 301, a RIP processing buffer memory 302, a direct memory access (DMA) controller 303, a binarization processor 304, a compression/decompression processor 305, a file memory 306, a resolution processor 307, a print controller 309, and a detection processor 311.

Each of the RIP processor 301, the DMA controller 303, the binarization processor 304, the compression/decompression processor 305, the resolution processor 307, the print controller 309, and the detection processor 311 is implemented by one or more processors. Each of these components is implemented by a general-purpose processor and/or a dedicated processor (e.g., hardware such as an ASIC) executing a given program. Each of the RIP processing buffer memory 302 and the file memory 306 is implemented by a memory.

The RIP processor 301 rasterizes input image data, and stores the rasterized image data in the RIP processing buffer memory 302. The RIP processing buffer memory 302 stores data in page units. The DMA controller 303 transfers the image data stored in the RIP processing buffer memory 302 to each component in the image processor 107 in page units.

More specifically, the DMA controller 303 transfers the image data that has been classified into high resolution to the binarization processor 304, the resolution processor 307, or the detection processor 311, and transfers the image data that has been classified into low resolution to the compression/decompression processor 305. In one example, the DMA controller 303 classifies image data having a resolution equal to or less than a given threshold to low resolution, and classifies image data having a resolution exceeding the threshold to high resolution. In one example, the threshold is 600 dot per inch (dpi). Although, in the present embodiment, the DMA controller 303 has a path for transferring image data to the detection processor 311 without using the resolution processor 307, the DMA controller 303 is not required to have the path, and may transfer the image data to the detection processor 311 only by using the resolution processor 307. The DMA controller 303 is not required to have the RIP processing buffer memory 302. The DMA controller 303 may sequentially transfer the data that has been subjected to the RIP processing.

In one example, image data of 600 dpi and image data of 1200 dpi can be input to the image forming apparatus 100. In this case, the image data of 600 dpi is handled as low-resolution image data. The image data of 1200 dpi is handled as high-resolution image data.

The binarization processor 304 binarizes the high-resolution image data. The DMA controller 303 transfers the image data that has been binarized by the binarization processor 304 to the compression/decompression processor 305.

The compression/decompression processor 305 compresses the image data. The DMA controller 303 transfers the compressed image data to the file memory 306.

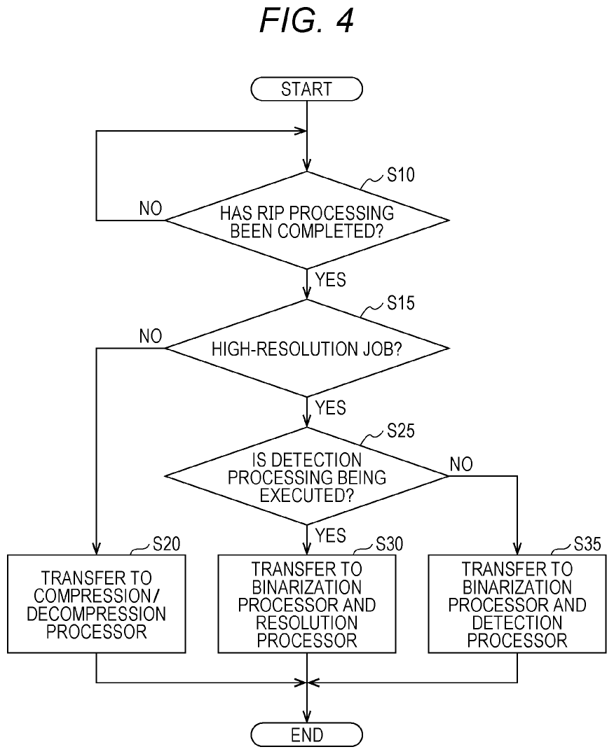

When the image data input to the image processor 107 has a high resolution, the DMA controller 303 transfers the image data to the resolution processor 307 or the detection processor 311 in parallel with transferring the image data read from the RIP processing buffer memory 302 to the binarization processor 304 in accordance with the condition described later with reference to FIG. 4.

The resolution processor 307 converts the resolution of the high-resolution image data into a predetermined resolution so that the detection processor 311 performs detection processing. This is preprocessing for the detection processing.

The detection processor 311 performs detection processing of detecting a specific image pattern in the image data. The specific image pattern constitutes an image such as bank bills and securities whose output is prohibited. The detection processor 311 outputs a result of the detection processing to the DMA controller 303.

The detection processor 311 makes an adjustment for converting the input image data such that the data has a predetermined resolution as preprocessing for detecting a specific image pattern. The predetermined resolution is the same as the resolution converted by the resolution processor 307. When the resolution processor 307 has already converted the input image data such that the image has the predetermined resolution, the detection processor 311 does not perform processing of converting the resolution. In this case, the period of time for the detection processing performed by the detection processor 311 is reduced.

In the embodiment, the image data input to the detection processor 311 is not subjected to the binarization processing regardless of whether the image data has a low resolution or a high resolution. This does not impair accuracy of detection processing performed by the detection processor 311.

The DMA controller 303 transfers the image data that has been decompressed by the compression/decompression processor 305 to the print controller 309 on condition that the image data is determined not to have the above-described specific image pattern in the detection processing. When the image data is determined to have the above-described specific image pattern in the detection processing, the DMA controller 303 does not transfer the image data to the print controller 309.

This prevents an image in accordance with image data that may contain a specific image pattern from being formed in the image forming apparatus 100. In this case, the DMA controller 303 may notify the controller 101 of detection processing for the image data. In response, the controller 101 may display, on the display 102, information indicating that image data contains (possibly) an image whose printing is prohibited.

The print controller 309 transfers the image data to the image former 108, and controls the image former 108 such that the image former 108 forms an image on a recording medium such as printing paper in accordance with the image data.

### [Processing Flow]

FIG. 4 is a flowchart of processing of transferring input image data in the image processor 107. The processing is executed by a hardware element that implements the DMA controller 303. In one example, the processing is implemented by a given hardware element (circuitry) executing a given program.

The processing in FIG. 4 is started in response to an instruction to execute a print job input from the user terminal 200 to the image forming apparatus 100. The processing in FIG. 4 is required to be started along with an instruction to execute a job including image formation. The processing may be started in response to an instruction (e.g., pressing a copy button) to execute a copy job in the image forming apparatus 100.

In step S10, the DMA controller 303 determines whether the RIP processing (rasterization performed by the RIP processor 301) for image data input to the image processor 107 has been completed. If determining that the RIP processing has not been completed, the DMA controller 303 keeps control in step S10 (NO in step S10). If determining that the RIP processing has been completed, the DMA controller 303 advances the control to step S15 (YES in step S10).

In step S15, the DMA controller 303 determines whether the image data, whose image is to be formed in a job, has a high resolution. In one example, when a file, for which a printing instruction is to be given in the job, contains a high-resolution image, the DMA controller 303 determines the above-described image data to have a high resolution (e.g., resolution exceeding 600 dpi). In another example, when the above-described image data does not contain a high-resolution image, the DMA controller 303 determines that the above-described image data does not have a high resolution. If determining that the above-described image data does not have a high resolution, the DMA controller 303 advances the control to step S20 (NO in step S15). Otherwise, the DMA controller 303 advances the control to step S25 (YES in step S15).

In step S20, the DMA controller 303 transfers the above-described image data to the compression/decompression processor 305, and ends the processing.

In step S25, the DMA controller 303 determines whether the detection processor 311 is working. If determining that the detection processor 311 is working, the DMA controller 303 advances the control to step S30 (YES in step S25). Otherwise, the DMA controller 303 advances the control to step S35 (NO in step S25).

In step S30, the DMA controller 303 transfers the above-described image data to the binarization processor 304 and the resolution processor 307, and ends the processing.

In step S35, the DMA controller 303 transfers the above-described image data to the binarization processor 304, and ends the processing.

### [Timing Chart]

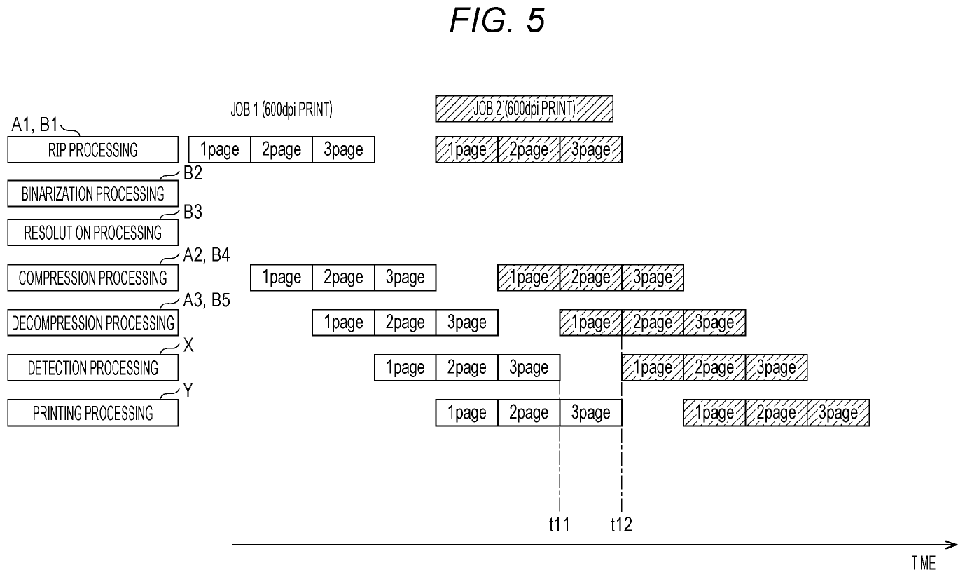

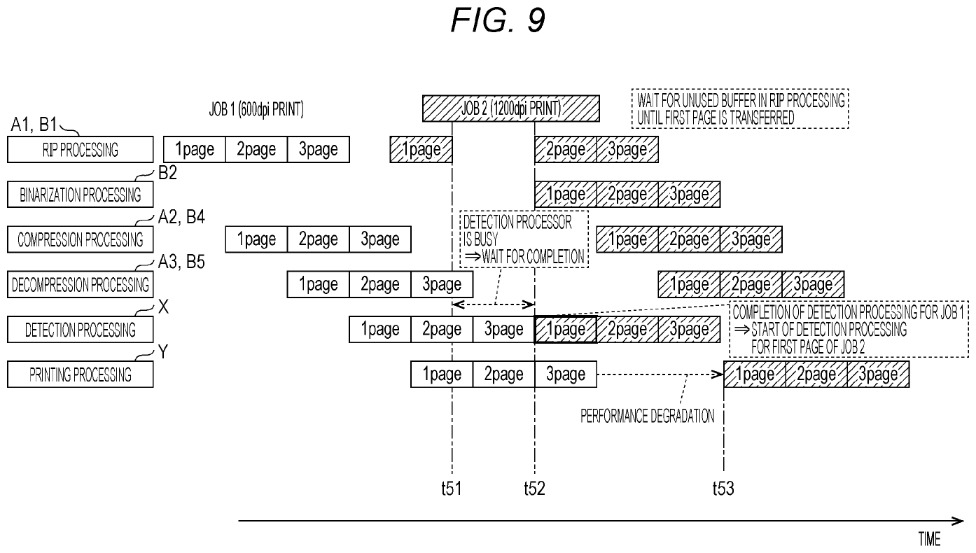

FIGS. 5 to 8 illustrate examples of a timing chart of processing in an image processor in the image forming apparatus 100 according to the disclosure. FIG. 9 illustrates one example of a timing chart of processing in an image processor in an image forming apparatus of a comparative example. Each of FIGS. 5 to 9 illustrates a timing chart at the time when two consecutive print jobs (“Job 1” and “Job 2” in each drawing) are executed. In each example in FIGS. 5 to 9, each of “Job 1” and “Job 2” represents a job of a file containing image data of three pages.

Each of FIGS. 5 to 9 illustrates processing performed on image data, such as “RIP processing”. More specifically, RIP processing (rasterization) A1 performed by the RIP processor 301, compression processing A2 and decompression processing A3 performed by the compression/decompression processor 305, detection processing X performed by the detection processor 311, and printing processing Y performed by the print controller 309 are illustrated as processing performed on low-resolution image data.

RIP processing (rasterization) B1 performed by the RIP processor 301, binarization processing B2 performed by the binarization processor 304, resolution processing B3 performed by the resolution processor 307, compression processing B4 and decompression processing B5 performed by the compression/decompression processor 305, detection processing X performed by the detection processor 311, and printing processing Y performed by the print controller 309 are illustrated as processing performed on high-resolution image data. The image forming apparatus of the comparative example in FIG. 9 does not have the resolution processor 307.

In each of FIGS. 5 to 9, the horizontal axis represents passage of time. FIGS. 5 to 9 illustrate image data of which page of which job each processing is directed to. Each of FIGS. 5 to 9 will be described below.

(FIG. 5: Case where Low-Resolution Jobs are Continually Executed)

FIG. 5 is a timing chart in the case where low-resolution jobs are continually executed. In the example of FIG. 5, both Job 1 and Job 2 are print jobs for printing low-resolution image data. As illustrated in FIG. 5, the RIP processing A1 is first performed on image data of the first page of Job 1. When the RIP processing on the image data of the first page of Job 1 is completed, the image data of the first page is transferred to the compression/decompression processor 305, and the RIP processing A1 on image data of the second page is performed. In this way, each of pieces of image data of the first to third pages of Job 1 is sequentially subjected to the RIP processing A1, the compression processing A2, and the decompression processing A3. Each image data is subjected to the detection processing X after the decompression processing A3 is finished. When the detection processing X on each page is completed, the printing processing Y on the page is performed on condition that the above-mentioned specific image pattern has not been detected in the detection processing.

In the example of FIG. 5, the RIP processing A1 on the top page (first page) of Job 2 starts after the RIP processing A1 on the last page (third page) of Job 1. Each of pieces of image data of the first to third pages of Job 2 is also sequentially subjected to the RIP processing A1, the compression processing A2, and the decompression processing A3.

In the example of FIG. 5, the decompression processing A3 on the first page of Job 2 ends at a time t12. The detection processing X on the third page of Job 1 ends at a time t11 before the time t12. That is, the detection processing X on the top page of Job 2 can start without waiting for the end of the detection processing X on the last page of Job 1. In the example of FIG. 5, the jobs have the same resolution, and thus no delay is caused by waiting for the processing on the image data of Job 1 in the processing on the image data of Job 2.

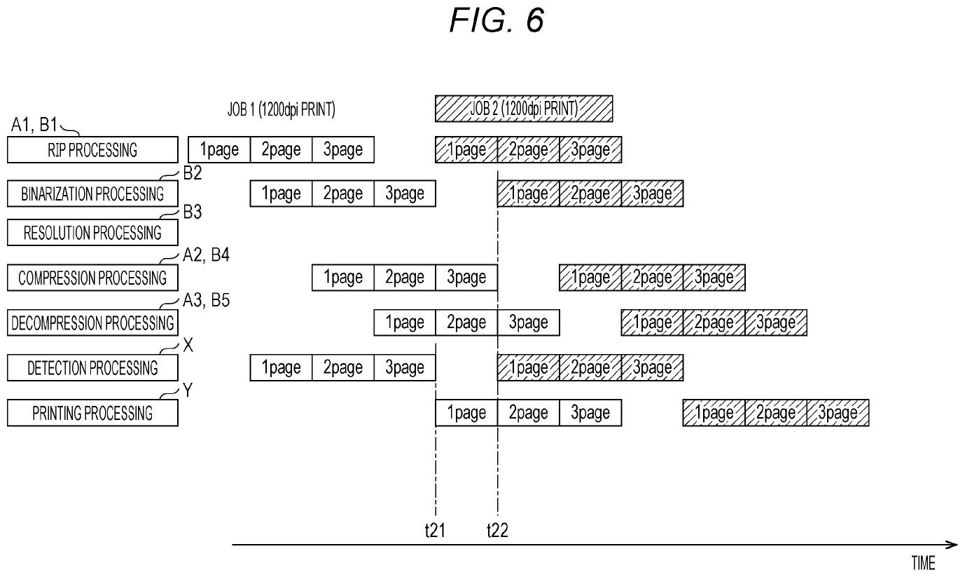

(FIG. 6: Case where High-Resolution Jobs are Continually Executed)

FIG. 6 is a timing chart in the case where high-resolution jobs are continually executed. In the example of FIG. 6, both Job 1 and Job 2 are print jobs for printing high-resolution image data. As illustrated in FIG. 6, the RIP processing B1 is first performed on image data of the first page of Job 1. When the RIP processing on the image data of the first page of Job 1 is completed, the image data of the first page is transferred to the binarization processor 304. At this time, there is no job that has been processed before Job 1, and thus the detection processor 311 is not working. The image data is transferred to each of the binarization processor 304 and the detection processor 311 (NO in step S25 in FIG. 4).

The image data of the first page of Job 1 is transferred to each of the binarization processing B2 and the detection processor 311, and the RIP processing B1 on the image data of the second page is performed. In this way, each of pieces of image data of the first to third pages of Job 1 is sequentially subjected to the RIP processing B1, the binarization processing B2, the resolution processing B3, the compression processing B4, and the decompression processing B5. There is no job before Job 1, and the detection processor 311 is thus not working.

Each image data of Job 1 is subjected to the detection processing X after the RIP processing B1 is finished. When the detection processing X and the decompression processing B5 on each page are completed, the printing processing Y on the page is performed on condition that the above-mentioned specific image pattern has not been detected in the detection processing.

In the example of FIG. 6, the RIP processing B1 on the top page (first page) of Job 2 starts after the RIP processing B1 on the last page (third page) of Job 1. Image data of the first to third pages of Job 2 has a high resolution, and each image data is sequentially subjected to the RIP processing B1, the binarization processing B2, the resolution processing B3, the compression processing B4, and the decompression processing B5.

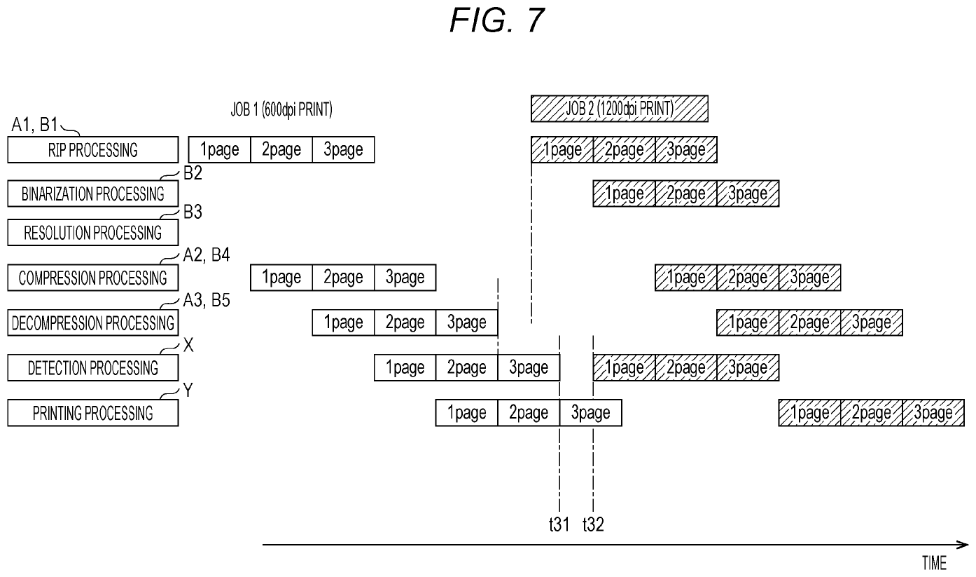

In the example of FIG. 6, the RIP processing B1 on the first page of Job 2 ends at a time t22. In contrast, the detection processing X on the third page of Job 1 ends at a time t21 before the time t22. That is, when trying to perform the binarization processing B2 on the first page of Job 2, the image processor 107 (DMA controller 303) can determine that the detection processor 311 is not working (NO in step S25 in FIG. 4). In the example of FIG. 7, the DMA controller 303 transfers the image data of Job 2 not to the resolution processor 307 but to the detection processor 311.

That is, the detection processing X on the top page of Job 2 can start without waiting for the end of the detection processing X on the last page of Job 1. In the example of FIG. 6, resolutions are the same between the jobs, and thus no delay is caused by waiting for the processing on the image data of Job 1 in the processing on the image data of Job 2.

(Case of Executing Jobs with Different Resolutions)

The image processor 107 performs different contents of processing for a low-resolution job and a high-resolution job. As can be seen from FIGS. 5 and 6, the start timing of the detection processing on a low-resolution job and that on a high-resolution job are different. In a low-resolution job, the DMA controller 303 transfers image data to the detection processor 311 after the completion of the decompression processing. In a high-resolution job, the DMA controller 303 transfers image data to the detection processor 311 after the completion of the RIP processing.

That is, the timing for starting the detection processing on a low-resolution job comes relatively later in the entire job. The timing for starting the detection processing on a high-resolution job comes relatively early in the entire job.

Due to the difference in the pieces of timing of starting the detection processing, the DMA controller 303 sometimes cannot transfer the high-resolution image data to the detection processor 311 since the detection processor 311 is performing processing on the low-resolution image data at the time when the DMA controller 303 tries to transfer the high-resolution image data to the detection processor 311. The image processor 107 needs to wait for the detection processor 311 to finish the processing on the low-resolution image data, which may cause a delay in processing.

In contrast, when executing a low-resolution job following a high-resolution job, the DMA controller 303 can transfer high-resolution image data to the detection processor 311 since the detection processor 311 has finished the processing on the high-resolution image data at the time when the DMA controller 303 tries to transfer the low-resolution image data to the detection processor 311. The image processor 107 does not need to wait for the detection processor 311 to finish the processing on the high-resolution image data, and a delay in processing does not occur.

FIGS. 7 to 9 illustrate examples of a timing chart in the case of executing a high-resolution job after a low-resolution job. An example in which the processing is delayed and a method of avoiding the delay will be described below with reference to these figures.

The example in which the processing is delayed will first be described with reference to FIG. 9. FIG. 9 illustrates one example of a timing chart in the case where a high-resolution job is executed after a low-resolution job and a delay occurs. The example of FIG. 9 illustrates print jobs. Low-resolution image data is printed in Job 1. High-resolution image data is printed in Job 2.

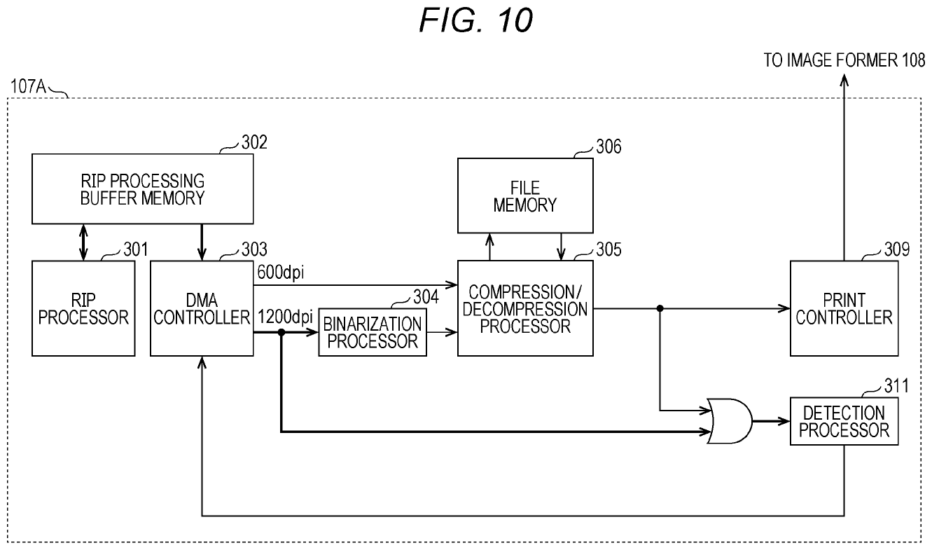

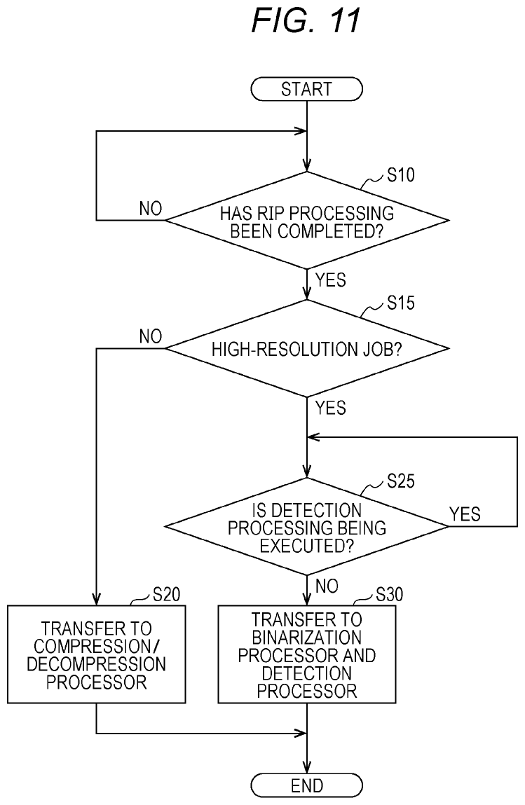

FIG. 9 illustrates an example for comparison with the image forming apparatus of the embodiment. The comparative example in FIG. 9 will be described here in more detail with reference to FIGS. 10 and 11. FIG. 10 illustrates one example of the configuration of an image processor 107A corresponding to the example of FIG. 9. The image processor 107A corresponding to the example of FIG. 9 does not include the resolution processor 307 unlike the image processor 107 of the embodiment.

FIG. 11 is a flowchart of processing, which corresponds to the example of FIG. 9, of transferring input image data to the image processor 107A. The configuration of FIG. 10 does not include the resolution processor 307 as compared to the configuration of FIG. 3. In the example of FIG. 10, when the image data has a high resolution, the DMA controller 303 transfers the image data to the binarization processor 304 and the detection processor 311. When the detection processor 311 is performing detection processing on another piece of image data, the DMA controller 303 transfers the next image data to the detection processor 311 after the end of the detection processing on the image data.

In the processing of FIG. 11, as compared to the processing of FIG. 4, if the DMA controller 303 determines that the detection processor 311 is working (YES in step S25), the DMA controller 303 keeps control in step S25 until the detection processor 311 stops working. The DMA controller 303 transfers the image data to the binarization processor 304 and the detection processor 311 on condition that the detection processor 311 is determined not to be working (NO in step S25).

Referring to FIG. 9, as in the example of FIG. 5, each of pieces of image data of the first to third pages of Job 1 is sequentially subjected to the RIP processing A1, the compression processing A2, and the decompression processing A3. Each image data is subjected to the detection processing X after the decompression processing A3 is finished. When the detection processing X on each page is completed, the printing processing Y on the page is performed on condition that the above-mentioned specific image pattern has not been detected in the detection processing.

In the example of FIG. 9, the RIP processing B1 of the first page of Job 2 is started at the timing when printing processing on the first page of Job 1 ends and a predetermined period of time has elapsed. Each of pieces of image data of the first to third pages of Job 2 is sequentially subjected to the RIP processing B1, the binarization processing B2, the resolution processing B3, the compression processing B4, and the decompression processing B5.

Even if the RIP processing B1 on the image data of Job 2 ends at a time t51, the image data of Job 1 is subjected to the detection processing X. Consequently, the DMA controller 303 cannot transfer the image data of the first page of Job 2 from the RIP processing buffer memory 302 to the detection processor 311. Since the image data of the first page of Job 2 is stored in the RIP processing buffer memory 302, the RIP processor 301 cannot start the RIP processing B1 on the image data of the second page of Job 2.

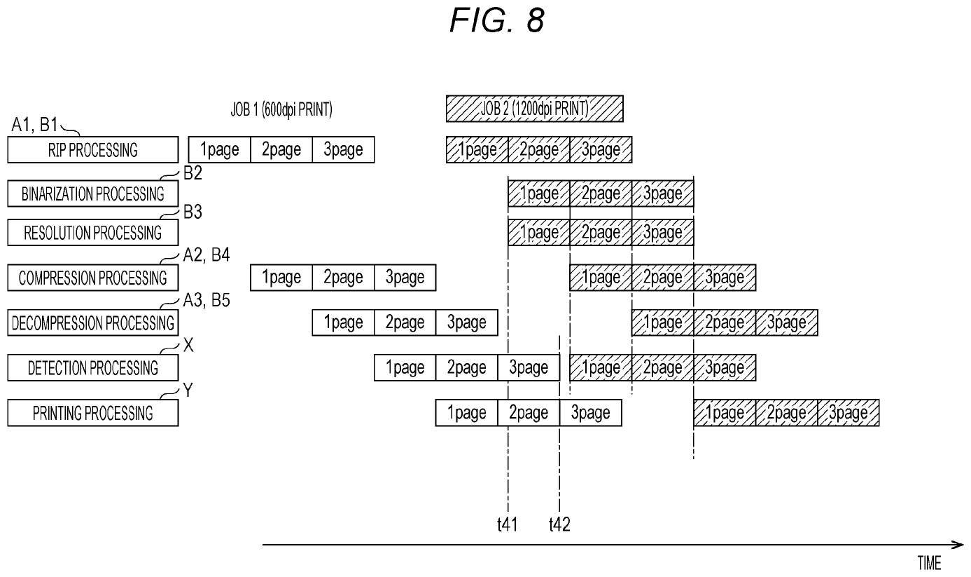

The DMA controller 303 starts transferring the image data of the first page of Job 1 to the detection processor 311 at a time t52. This causes the DMA controller 303 to start the RIP processing on the image data of the second page of Job 2 at the time t52. That is, since the example of FIG. 9 does not include the resolution processing B3, there is no path that advances the image data to the compression processing B4 and the decompression processing B5 after the RIP processing B1. This greatly delays the start of the RIP processing B1 on the image data of the second page of Job 2 compared to the example of FIG. 8, and also delays the start of the processing after the binarization processing B2 on the image data of the second page. This delays the end of the decompression processing B5 compared to the example of FIG. 8 even if the detection processing X on each page is finished first in Job 2. As a result, the start of the printing processing Y is delayed, and the processing is delayed (time t53).

In order to avoid the delay, the start timing of Job 2 is required to be delayed. Returning from the comparative example in FIGS. 9 to 11 to the image forming apparatus 100 of the embodiment, an example in which no delay occurs will be specifically described below with reference to FIG. 7. FIG. 7 illustrates one example of a timing chart in the case where a high-resolution job is executed after a low-resolution job and no delay occurs. The example of FIG. 7 illustrates print jobs. Low-resolution image data is printed in Job 1. High-resolution image data is printed in Job 2.

As in the example of FIG. 5, each of pieces of image data of the first to third pages of Job 1 in the example of FIG. 7 is sequentially subjected to the RIP processing A1, the compression processing A2, and the decompression processing A3. Each image data is subjected to the detection processing X after the decompression processing A3 is finished. When the detection processing X on each page is completed, the printing processing Y on the page is performed on condition that the above-mentioned specific image pattern has not been detected in the detection processing.

In the example of FIG. 7, printing processing on the first page of Job 1 ends, and the RIP processing B1 of the first page of Job 2 is started. Each of pieces of image data of the first to third pages of Job 2 is sequentially subjected to the RIP processing B1, the binarization processing B2, the resolution processing B3, the compression processing B4, and the decompression processing B5.

In the example of FIG. 7, the RIP processing B1 on the first page of Job 2 ends, and the binarization processing B2 is started at a time t32. In contrast, the detection processing X on the final page of Job 1 ends at a time t31 before the time t32. That is, when performing the binarization processing B2 on the first page of Job 2, the image processor 107 (DMA controller 303) can determine that the detection processor 311 is not working (NO in step S25 in FIG. 4). In the example of FIG. 7, the DMA controller 303 transfers the image data of Job 2 not to the resolution processor 307 but to the detection processor 311. The detection processing on the image data of Job 2 is performed without waiting for the end of the detection processing on the image data of Job 1.

In the example of FIG. 7, however, the time required for the entire processing of Jobs 1 and 2 is increased compared to the example in FIG. 5 or 6. This is because the start time of the processing on the first page of Job 2 has been delayed. An example in which the delay is avoided by using the resolution processor 307 without increasing the entire processing time of Jobs 1 and 2 will be described below.

FIG. 8 illustrates one example of a timing chart in the case where a high-resolution job is executed after a low-resolution job and resolution processing is performed. The example of FIG. 8 illustrates print jobs as in the example of FIG. 7. Low-resolution image data is printed in Job 1. High-resolution image data is printed in Job 2.

Also in the example of FIG. 8, as in the example of FIG. 7, each of pieces of image data of the first to third pages of Job 1 is sequentially subjected to the RIP processing A1, the compression processing A2, and the decompression processing A3, and then subjected to the detection processing X. When the detection processing X on each page is completed, the printing processing Y on the page is performed on condition that the above-mentioned specific image pattern has not been detected in the detection processing.

In the example of FIG. 8, the RIP processing B1 on the image data of the first page of Job 2 starts relatively early after the end of the RIP processing A1 on the last page (third page) of Job 1. The detection processing X on the image data of the last page of Job 1 has not been finished yet at timing (time t41) when the RIP processing B1 on the image data on the first page of Job 2 is finished and the binarization processing B2 starts.

The detection processing X on the image data of the last page of Job 1 ends at a time t42 after the time t41. That is, the detection processor 311 is determined to be working at time t41 (YES in step S25).

In the example of FIG. 8, the image processor 107 (DMA controller 303) performs the resolution processing B3 in parallel with the binarization processing B2 and the detection processing X on the image data of Job 2 as described as the control of step S35. This causes the detection processing X on the image data of the first page of Job 2 to start at the timing of the time t42.

As described above, the resolution processing B3 corresponds to preprocessing for performing the detection processing X. The processing time of the detection processing X on the image data of Job 2 is reduced since the processing of the resolution processing B3 has been performed.

In other words, in the example of FIG. 8, the DMA controller 303 can select whether to direct the image data to the binarization processing B2 and the resolution processing B3 or to the binarization processing B2 and the detection processing X in accordance with the progress of the detection processing X on the image data of Job 1 before Job 2. This can avoid degradation in accuracy of detection processing and processing delay as much as possible in the image forming apparatus 100. Processing is performed in one circuit without providing a dedicated circuit for each of high-resolution data and low-resolution data, and thus a circuit scale is not increased, and a manufacturing cost is not significantly increased.

### BRIEF SUMMARY

As described above, the image forming apparatus 100 according to the first embodiment includes the image processor 107 and the image former 108. The image processor 107 performs predetermined processing on image data. The image former 108 forms an image of image data that has been subjected to the predetermined processing. The image processor 107 includes a file memory. When image data has a low resolution, the image processor 107 stores the image data in the file memory, and performs the detection processing X on the image data. In the detection processing X, it is detected whether the image data contains a predetermined pattern. When the image data has a high resolution, the image processor 107 performs the resolution processing B3 in parallel with the binarization processing B2, and performs the detection processing X on the image data. In the resolution processing B3, the image data is converted to have a predetermined resolution. This avoids a delay in the processing on the image data, and reduces manufacturing costs.

When first image data has a high resolution, and if the detection processing X is being performed on second low-resolution image data at the time when the binarization processing B2 on the first image data is performed, the image processor 107 performs the resolution processing B3 and binarization processing B2 in parallel on the first image data. If the detection processing X on the second low-resolution image data is not being performed, the image processor 107 performs the detection processing X on the first image data without performing the resolution processing B3. This enables the detection processing X without performing the resolution processing B3 when the detection processing X is not being performed.

The image processor 107 further includes the RIP processing buffer memory 302. The image processor 107 sequentially stores input image data in the RIP processing buffer memory 302. The image processor 107 reads image data from the RIP processing buffer memory 302 in predetermined units, and determines whether the image data has a low resolution or a high resolution. This enables the DMA controller 303 to determine whether each job has a low resolution or a high resolution, and perform processing.

The image processor 107 also stores image data, which has been subjected to image expansion processing of expanding the image data into bitmap format data, in the RIP processing buffer memory 302. This enables bitmap format image data to be subjected to processing.

When image data has a low resolution, the image processor 107 stores compressed image data in the file memory 306 without performing the binarization processing B2 and the resolution processing B3. The image processor 107 performs compression/decompression processing of decompressing and acquiring the image data, and then performs the detection processing X. This enables the detection processing X without the binarization processing B2 when the resolution is low, and the detection accuracy is not decreased.

When the image data has a high resolution, the image processor 107 performs the resolution processing B3, and performs the detection processing X without the compression/decompression processing on the image data. This enables the detection processing X without performing the compression/decompression processing on high-resolution image data.

A control method for the image forming apparatus according to the first embodiment includes: performing resolution determination of determining whether image data to be processed has a high resolution or a low resolution; storing the image data in a file memory and performing detection processing of detecting whether a predetermined pattern is contained, when the image data has a low resolution; and performing the resolution processing B3 of converting the image data to have a predetermined resolution in parallel with the binarization processing B2 and performing the detection processing on the image data, when the image data has a high resolution. This avoids a delay in the processing on the image data, and reduces manufacturing costs.

The control method further includes determining, when predetermined processing is performed on the image data, whether the detection processing X on another piece of image data is being performed. The resolution processing B3 is performed in parallel with the binarization processing B2, and the detection processing X is performed on the image data if the image data has a high resolution, the other image data has a low resolution, and the detection processing X is being performed. The detection processing X is performed without performing the resolution processing B3 on the image data if the image data has a high resolution, the other image data has a low resolution, and the detection processing X is not being performed. This enables the detection processing X without performing the resolution processing B3 when the detection processing X is not being performed.

The control method further includes performing buffer memory storage processing of sequentially storing input image data in the RIP processing buffer memory 302. In the performing the resolution determination, the image data is read from the RIP processing buffer memory 302 in predetermined units, and it is determined whether the image data has a low resolution or a high resolution. This enables the DMA controller 303 to determine whether each job has a low resolution or a high resolution, and perform processing.

In the performing the buffer memory storage processing, the image data, which has been subjected to image expansion processing of expanding the image data into bitmap format data, is stored in the RIP processing buffer memory 302. This enables bitmap format image data to be subjected to processing.

In the performing the detection processing X, when image data has a low resolution, compressed image data is stored in the file memory 306 without performing the binarization processing B2 and the resolution processing B3 on the image data. The compression/decompression processing of decompressing and acquiring the image data is performed, and then the detection processing X is performed. This enables the detection processing X without the binarization processing B2 when the resolution is low, and the detection accuracy is not decreased.

In the performing the detection processing X, when the image data has a high resolution, the resolution processing B3 is performed, and the detection processing X is performed without performing the compression/decompression processing on the image data. This enables the detection processing X without performing the compression/decompression processing on high-resolution image data.

A program according to the first embodiment causes one or more processors to perform the control method for the above-described image forming apparatus by being executed by the one or more processors. This avoids a delay in the processing on the image data, and reduces manufacturing costs.

Although an embodiment of the present invention has been described and illustrated in detail, the disclosed embodiment is made for purposes of illustration and example only and not limitation. The scope of the present invention should be interpreted by terms of the appended claims, and all modifications within a meaning and scope equivalent to the claims are intended to be included in the scope of the present invention.

What is claimed is:

1. An image forming apparatus comprising:
an image processor that performs predetermined processing on image data; and
an image former that forms an image of the image data that has been subjected to the predetermined processing,
wherein the image processor:
includes a file memory;
when image data has a low resolution, stores the image data in the file memory, and performs detection processing of detecting whether a predetermined pattern is contained on the image data; and
when image data has a high resolution, performs resolution processing of converting the image data to have a predetermined resolution in parallel with binarization processing, and performs the detection processing on the image data.

2. The image forming apparatus according to claim 1,
wherein, when first image data has a high resolution and the binarization processing on the first image data is performed, the image processor:
performs the resolution processing and the binarization processing in parallel on the first image data if the detection processing on second low-resolution image data is being performed; and
performs the detection processing without performing the resolution processing on the first image data if the detection processing on the second low-resolution image data is not being performed.

3. The image forming apparatus according to claim 1,
wherein the image processor further includes a buffer memory,
sequentially stores input image data in the buffer memory, reads image data from the buffer memory in predetermined units, and determines whether the image data has a low resolution or a high resolution.

4. The image forming apparatus according to claim 3,
wherein the image processor stores image data, which has been subjected to image expansion processing of expanding the image data into bitmap format data, in the buffer memory.

5. The image forming apparatus according to claim 1,
wherein, when image data has a low resolution, the image processor stores compressed image data in the file memory without performing the binarization processing and the resolution processing, performs compression/decompression processing of decompressing and acquiring the image data, and performs the detection processing.

6. The image forming apparatus according to claim 5,
wherein, when image data has a high resolution, the image processor performs the resolution processing, and performs the detection processing without performing the compression/decompression processing on the image data.

7. A control method for an image forming apparatus, the method comprising:
performing resolution determination of determining whether image data to be processed has a high resolution or a low resolution;
storing the image data in a file memory and performing detection processing of detecting whether a predetermined pattern is contained, when the image data has a low resolution; and
performing resolution processing of converting the image data to have a predetermined resolution in parallel with binarization processing and performing the detection processing on the image data, when the image data has a high resolution.

8. The control method according to claim 7, further comprising determining, when predetermined processing is performed on the image data, whether the detection processing on another piece of image data is being performed,
wherein the method includes:
performing the resolution processing in parallel with binarization processing and performing the detection processing on the image data if the image data has a high resolution, the other image data has a low resolution, and the detection processing is being performed; and
performing the detection processing without performing the resolution processing on the image data if the image data has a high resolution, the other image data has a low resolution, and the detection processing is not being performed.

9. The control method according to claim 7, further comprising performing buffer memory storage processing of sequentially storing input image data in a buffer memory,
wherein, in the performing the resolution determination, the image data is read from the buffer memory in predetermined units, and it is determined whether the image data has a low resolution or a high resolution.

10. The control method according to claim 9,
wherein, in the performing the buffer memory storage processing, the image data, which has been subjected to image expansion processing of expanding the image data into bitmap format data, is stored in the buffer memory.

11. The control method according to claim 7,
wherein, in the performing the detection processing, when the image data has a low resolution, compressed image data is stored in the file memory without performing the binarization processing and the resolution processing on the image data, compression/decompression processing of decompressing and acquiring the image data is performed, and the detection processing is performed.

12. The control method according to claim 11,
wherein, in the performing the detection processing, when the image data has a high resolution, the resolution processing is performed, and the detection processing is performed without performing the compression/decompression processing on the image data.

13. A non-transitory recording medium storing a computer readable program causing one or more processors to perform the control method according to claim 7 by being executed by the one or more processors.
